(19) United States
(12) Patent Application Publication
(10) Pub. No.: US 2026/0244633 A1
(43) Pub. Date: Aug. 20, 2026

(54) SYSTEMS AND METHODS FOR SEQUENTIAL AND POTENTIALLY OVERLAPPING APPLICATION PROGRAMMING INTERFACE REQUESTS

(71) Applicant: Capital One Services, LLC, McLean, VA (US)

(72) Inventor: David Aaron Pinski, Merion Station, PA (US)

(73) Assignee: Capital One Services, LLC, McLean, VA (US)

(21) Appl. No.: 19/054,335

(22) Filed: Feb. 14, 2025

(51) Int. Cl. G06F 16/2458; G06F 16/23

(52) U.S. Cl. CPC G06F 16/2474; G06F 16/2322

(57) ABSTRACT

Systems and methods use requests with triangulating time stamps. In particular, each request includes an effective date time stamp, an active date time stamp, and a deployment date time stamp. The use of the triangulating time stamps allows the system to use synchronous exeution, but also allow for requests to be reversed and/or back dated. For example, the effective date time stamp is used to indicate when a request is first processed. The active date time stamp indicates when the request should be used. The deployment date time stamp indicates when the request was first deployed (e.g., received), which may be used for audit or reference purposes.

### BACKGROUND

Modern computer applications communicate with each other primarily through the use of application programming interfaces (APIs), which allow different software systems to exchange data and functionality in a standardized way. APIs define a set of rules and protocols that enable one application to access features or data from another application, often over the internet. For instance, web-based services like social media platforms, payment gateways, and cloud storage systems offer APIs that other applications can call to retrieve information, send data, or trigger actions. These communications are typically carried out over HTTP or HTTPS protocols, ensuring secure data transfer. In addition to APIs, some systems use message queues or event-driven architectures, where applications send messages or events to a central message broker (like RabbitMQ or Apache Kafka), which distributes the messages to other services or applications that are subscribed to those events. Another common method of communication is through remote procedure calls (RPC), where one application directly invokes a function or process on another application, often over a network. Modern implementations of RPC, such as gRPC or SOAP, are commonly used in microservices architectures where multiple small services need to interact efficiently. Additionally, webhooks are frequently used for asynchronous communication, where an application sends real-time data or notifications to another application when specific events occur, without the need for continuous polling. In some cases, especially in highly integrated environments, applications may share data through databases or shared data storage, where one application writes to the database and another reads from it.

### SUMMARY

Systems and methods are described herein for improvements to computing processing of sequential and potentially overlapping requests. For example, existing systems maintain sequential processing of requests through synchronous execution, where requests are processed one after another in a well-defined sequence. As such, each request must complete before the next one begins. For example, API requests or database transactions are required to handle request synchronously to ensure that each operation occurs only after the previous one has finished, maintaining data integrity and avoiding conflicts.

Managing sequential and potentially overlapping API requests is crucial for ensuring system efficiency, data consistency, and optimal performance in modern applications. For example, when multiple API requests are made in sequence or overlap in time, particularly in high-traffic systems, failing to handle them properly can lead to issues like race conditions, where the outcome depends on the order in which requests are processed. For instance, if two overlapping requests attempt to modify the same data simultaneously, the result may be unexpected or inconsistent, leading to data corruption or integrity problems. Sequentially handling requests ensures that one process completes before another begins, which is especially important in cases where one request depends on the outcome of a previous request.

Additionally, managing overlapping requests helps optimize system resources. If too many overlapping requests are sent to an API, it can overwhelm the server, leading to performance bottlenecks, high latency, or even system crashes. Implementing techniques like rate limiting, request queuing, and throttling helps regulate the flow of requests to avoid server overload and ensure fair usage across clients. Moreover, handling such requests efficiently can improve user experience by minimizing delays and ensuring that users receive the most up-to-date and accurate information. This is especially important in real-time systems where multiple users may interact with the same resources, such as in collaborative applications, e-commerce, or financial systems.

Proper management of sequential and overlapping API requests is also essential for scalability. In distributed systems or microservice architectures, where many services interact through APIs, handling overlapping requests efficiently ensures that the system can scale smoothly and maintain high availability, even under heavy loads. Overall, managing these requests effectively is key to maintaining system stability, ensuring data integrity, and delivering a reliable user experience.

However, synchronous execution comes with several technical drawbacks. For example, due to synchronous execution, requests must be processed in the order in which they are received. This creates problems when a request needs to be changed or modified. As one example, a request may be issued, but prior to its execution (or after), in which an error is found. Due to synchronous execution, the request cannot be reversed prior to processing (or deleted during or after processing). Instead, the request must be processed, and a second request must be issued to negate the result of the original request and return the system state to its original condition.

To further exacerbate this technical drawback, each request may trigger subsequent requests and dependent tasks. In turn, each of these must then be negated by a corresponding follow-up request. This can lead to millions of redundant processing requests across computer systems, which wastes computer resources and causes system slowdowns. Moreover, in applications that share data through databases or shared data storage, data must be corrected in the databases via separate requests. Similarly, any downstream effects to changes in the databases (e.g., changes to dependent values) must also be corrected.

To overcome these technical deficiencies in processing sequential and potentially overlapping requests, systems and methods disclosed herein use requests with triangulating time stamps. In particular, each request includes an effective date time stamp, an active date time stamp, and a deployment date time stamp. The use of the triangulating time stamps allows the system to use synchronous execution but also allow for requests to be reversed and/or back dated. For example, while a conventional synchronous execution request does not include any time stamps (i.e., it is processed with received), the systems and methods use requests with three different time stamps. For example, the effective date time stamp is used to indicate when a request is first processed. The active date time stamp indicates when the request should be used. The deployment date time stamp indicates when the request was first deployed (e.g., received), which may be used for audit or reference purposes. By using the requests with the varying time stamps, the system may determine when a given request should be processed, backdated, and/or reversed while still allowing for synchronous execution.

In some aspects, systems and methods for processing sequential and potentially overlapping requests using triangulating time stamps are described. For example, the system may retrieve a first plurality of serial data values in a first database, wherein each data value of the first plurality of serial data values corresponds to a respective result of a respective processing request performed at a respective time point. The system may receive, at a first time point, a first processing request for re-processing one or more of the first plurality of serial data values, wherein the first processing request comprises an effective date time stamp indicating when the first processing request is effective to generate a result, an active date time stamp indicating when the first processing request is active, and a deployment date time stamp indicating when the first processing request is deployed. The system may select, based on the active date time stamp, a first data value of the first plurality of serial data values for reprocessing. The system may execute the first processing request on the first data value.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram of a calendar view of a system implementing requests comprising triangulating time stamps, with in accordance with one or more embodiments.

FIG. 2 shows an illustrative diagram of a logbook view of a system implementing requests comprising triangulating time stamps, with in accordance with one or more embodiments.

FIG. 3 shows illustrative components for a system for providing triangulating time stamps, in accordance with one or more embodiments.

FIG. 4 shows a flowchart of the steps involved in processing sequential and potentially overlapping requests using triangulating time stamps, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

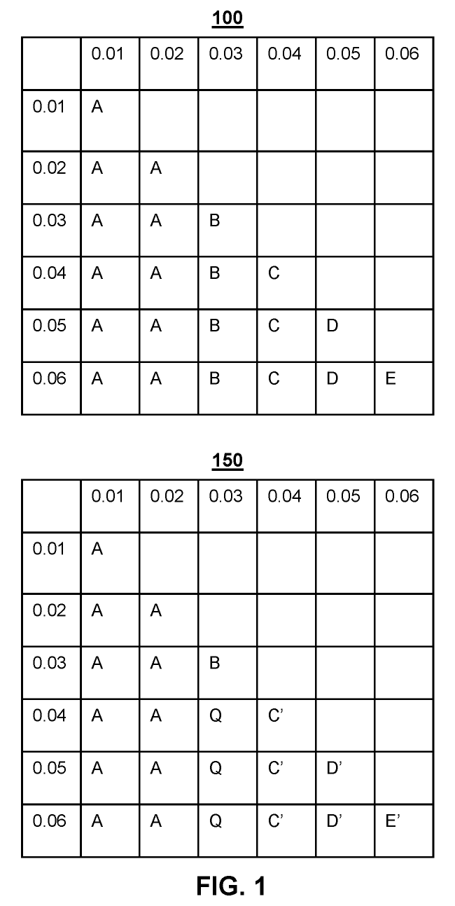

FIG. 1 shows an illustrative diagram of a calendar view of a system implementing requests comprising triangulating time stamps, in accordance with one or more embodiments. For example, FIG. 1 includes two tables that illustrate how data values may be updated using triangulating time stamps.

For example, table 100 represents data values prior to a retroactive reprocessing of data. In contrast, table 150 shows data values after reprocessing data using triangulating time stamps. For example, table 100 may illustrate data populated using synchronous execution. That is, new data is generated in series at every one-hundredth of a second. In contrast, table 150 shows the data after a retroactive reprocessing at “0.03” seconds.

For example, due to synchronous execution, data may be processed in the order in which it is received. In some embodiments, this data may comprise time-series data. As described herein, “time-series data” may include a sequence of data points that occur in successive order over some period of time. In some embodiments, time-series data may be contrasted with cross-sectional data, which captures a point-in-time. A time series can be taken on any variable that changes over time. The system may use a time series to track the variable (e.g., price) of an asset (e.g., security) over time. This can be tracked over the short term, such as the price of a security on the hour over the course of a business day, or the long term, such as the price of a security at close on the last day of every month over the course of five years. The system may generate a time series analysis. For example, a time series analysis may be useful to see how a given asset, security, or economic variable changes over time. It can also be used to examine how the changes associated with the chosen data point compare to shifts in other variables over the same time period. For example, with regards to retail loss, the system may receive time series data for the various sub-segments indicating daily values for theft, product returns, etc.

The time-series analysis may determine various trends such as a secular trend, which describe the movement along the term, a seasonal variation, which represent seasonal changes, cyclical fluctuations, which correspond to periodical but not seasonal variations, and irregular variations, which are other nonrandom sources of variations of series. The system may maintain correlations for this data during modeling. In particular, the system may maintain correlations through non-normalization as normalizing data inherently changes the underlying data which may render correlations, if any, be undetectable and/or lead to the detect of false positive correlations. For example, modeling techniques (and the predictions generated by them), such as rarefying (e.g., resampling as if each sample has the same total counts), total sum scaling (e.g., dividing counts by the sequencing depth), and others, and the performance of some strongly parametric approaches, depends heavily on the normalization choices. Thus, normalization may lead to lower model performance and more model errors. The use of anon-parametric bias test alleviates the need for normalization, while still allowing the methods and systems to determine a respective proportion of error detections for each of the plurality of time-series data component models. Through this unconventional arrangement and architecture, the limitations of the conventional systems are overcome. For example, non-parametric bias tests are robust to irregular distributions, while providing an allowance for covariate adjustment. Since no distributional assumptions are made, these tests may be applied to data that has been processed under any normalization strategy or not processed under a normalization process at all.

As referred to herein, “a data stream” may refer to data that is received from a data source that is indexed or archived by time. This may include streaming data (e.g., as found in streaming media files) or may refer to data that is received from one or more sources over time (e.g., either continuously or in a sporadic nature). A data stream segment may refer to a state or instance of the data stream. For example, a state or instance may refer to a current set of data corresponding to a given time increment or index value. For example, the system may receive time series data as a data stream. A given increment (or instance) of the time series data may correspond to a data stream segment.

Table 100 may represent data from an instrument control data. An instrument control data table is a structured mechanism used to manage and track the specific versions of financial or processing instruments that are applied across accounts and transactions over time. The key purpose of this table is to ensure consistency and traceability in how transactions are processed, especially when dealing with complex portfolios or different versions of financial instruments.

For any given End of Day (EOD), this table ensures that all accounts within a given instrument class utilize the same version of the instrument for that day’s transactions. This means that transactions occurring on a specific day, whether historical or current, will reference the same instrument version, maintaining uniformity across all accounts processed under that instrument class. The instrument control data table is not only time-dependent but also based on effective dates, which dictate when a particular instrument version becomes applicable. Effective dates are day-based and do not account for specific times of day, meaning that the instrument version remains consistent for all transactions during a full day (e.g., as defined by a computer term, session, and/pr other metric). For example, in some embodiments, a full day may correspond to a processing period, length of time (e.g., a 25-hour period), and/or other predetermined or dynamically determined length of time.

Furthermore, the instrument control table plays a critical role in replays—scenarios where historical transactions or portions of a portfolio are recalculated using a different version of the instrument. In such cases, the system must track and apply the appropriate sequence of instruments over time, ensuring that the replay accurately reflects the conditions under which transactions were originally processed or any updates based on new instrument versions.

Each transaction and its corresponding output, known as evidence, is stored with a hash of the instrument used. This hash guarantees the integrity and immutability of the instrument: it cannot be altered without generating a new hash, ensuring that any changes to an instrument are immediately detected. As such, for any given day, with only the stored evidence and output, the system can reconstruct the exact calculations performed, including the instrument version and its corresponding code used during the transaction process.

The instrument control data table must always maintain a clear and consistent sequence of instrument versions from the past to the present, ensuring that there is no ambiguity in how transactions were processed over time. This structured approach guarantees that the system can not only support audits and replays but also maintain accurate, historical records of financial calculations, providing a full, transparent account of all instrument versions applied to transactions.

This creates problems when a request is issued that needs to change or modify data in table 100. As one example, a request may be issued, but prior to its execution (or after), in which an error is found. Due to synchronous execution, the request cannot be reversed prior to processing (or deleted during or after processing). Instead, the request must be processed, and a second request must be issued to negate the result of the original request and return the system state to its original condition.

For example, table 150 may indicate data values (e.g., an instrument control table) after a request has been received indicating that some data values require reprocessing. The system may use a request with a triangulating time stamp, which includes multiple time stamps indicating different types of data, to effectively manage and update data values in tables like an instrument control data table.

As described herein, a triangulating time stamp is a system mechanism that includes multiple time stamps within a single request, allowing for flexible processing, backdating, or reversing actions while still enabling synchronous execution. This approach may incorporate different types of time stamps: the effective date time stamp, the active date time stamp, and/or the deployment date time stamp, each serving a specific role in determining how and/or when a request is processed. The effective date time stamp marks when the request is first processed by the system, representing the moment when the system acknowledges and begins executing the request, such as recalculating data or applying a new instrument version. The active date time stamp specifies when the changes within the request should actually take effect, indicating the point in time when the system should use the updated information for calculations, even if the request was processed earlier or later. For instance, if a new financial instrument is being deployed, the active date tells the system when this new version should begin influencing transactions. The deployment date time stamp records when the request was initially deployed or received by the system, providing an audit trail and ensuring traceability of when changes were first introduced.

Using these time stamps, the system achieves synchronous execution, meaning requests are processed in real time upon receipt, while also offering flexibility for more complex scenarios. The triangulating time stamp allows the system to backdate requests by applying changes retroactively, using the active date to make the request effective in the past. It also supports reversing requests, where the system can undo changes by referencing both the deployment and active dates to revert to previous states. Additionally, the deployment date ensures an accurate audit record, showing when the request was first submitted, even if it impacts past or future periods. This structure provides a balance between immediate, real-time execution and the ability to manage historical changes or future scheduling with precision, enabling the system to maintain both flexibility and consistency in its data processing.

This triangulating time stamp allows the system to capture the relationships between various time dimensions, such as when an update request is made, the effective date of the new data (e.g., a new instrument version), and possibly the historical time period that the new data impacts. When such a request is processed, the system can deploy a new instrument version into the past by updating the relevant entries in the instrument control data table to reflect the new instrument sequence retroactively.

Once the new instrument version is deployed, the triangulating time stamp ensures that the system can precisely define which portion of the portfolio needs to be replayed using the new instrument. As shown in table 150, the system has detected that the portion of the portfolio to be reprocessed occurs at the “0.03” time point. This may involve recalculating transactions or recalibrating financial results based on the updated version of the instrument, ensuring consistency between past data and the newly deployed logic. The system can use the triangulated time stamps to control when these replays occur, either for individual accounts or groups of accounts, by aligning the effective date of the instrument version with the time stamps of transactions.

Furthermore, the system guarantees that all future replays and any additional processing will utilize the newly deployed instrument sequences. This means that once the new instrument version is deployed into the past, any future calculations or historical replays triggered by the system will automatically reference the updated sequence of instruments, preserving consistency in how data is processed. The triangulating time stamp, by tying together these multiple time dimensions, ensures that the system can manage complex scenarios involving retroactive changes while maintaining accuracy and traceability throughout the replay process.

For example, each request may include an effective date time stamp, an active date time stamp, and/or a deployment date time stamp. The use of the triangulating time stamps allow the system to use synchronous execution but also allow for requests to be reversed and/or back dated. For example, while a conventional synchronous execution request does not include any time stamps (i.e., it is processed with received), the systems and methods use requests with three different time stamps. For example, the effective date time stamp is used to indicate when a request is first processed. The active date time stamp indicates when the request should be used. The deployment date time stamp indicates when the request was first deployed (e.g., received), which may be used for audit or reference purposes. By using the requests with the varying time stamps, the system may determine when a given request should be processed, backdated, and/or reversed while still allowing for synchronous execution.

In some embodiments, the system may generate a representation of table 100 or table 150 in a user interface. As referred to herein, a “user interface” may comprise a human-computer interaction and communication in a device, and may include display screens, keyboards, a mouse, and the appearance of a desktop. For example, a user interface may comprise a way a user interacts with an application or a website. As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user. User profile data may also include a user characteristic. As referred to herein, “a user characteristic” may include information about a user and/or information included in a directory of stored user settings, preferences, and information for the user. For example, a user profile may have the settings for the user’s installed programs and operating system. In some embodiments, the user profile may be a visual display of personal data associated with a specific user, or a customized desktop environment. In some embodiments, the user profile may be digital representation of a person’s identity. The data in the user profile may be generated based on the system actively or passively monitoring.

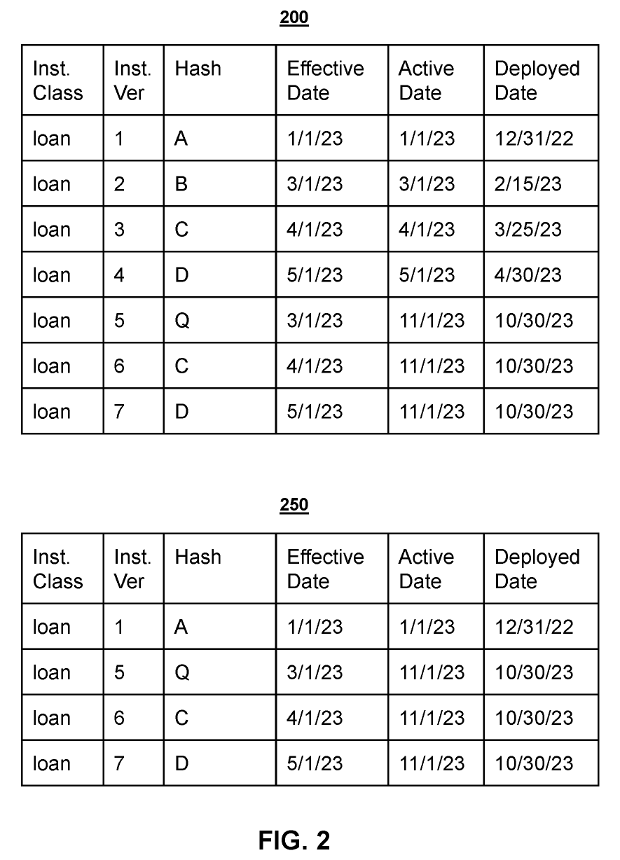

FIG. 2 shows an illustrative diagram of a logbook view of a system implementing requests comprising triangulating time stamps, with in accordance with one or more embodiments. For example, table 200 and table may represent a logbook for a given instrument (e.g., a “loan”). For example, table 200 and table 250 may show a logbook view in a user interface that is designed to display a comprehensive history of a given instrument, such as a loan, including its various versions, balances, and rule sets over time. This view typically presents a chronological timeline that tracks changes to the instrument, allowing users to see how the instrument has evolved. For example, if a loan has undergone multiple updates—such as changes in its interest rate, repayment terms, or applicable rule sets—each version of the loan would be represented as a distinct entry in the logbook. The system would indicate the effective date of each change, highlighting when a specific version was active and what modifications were made. The logbook view may also show key financial metrics, like the loan’s balance at different time points, allowing users to track how the balance changed due to payments, interest accruals, or other financial transactions. If different rule sets were applied to the loan, such as changes in interest calculation methods or risk assessment models, these rule sets would be clearly noted in the logbook for the relevant time periods. Each entry could include a summary of the rule set applied, providing transparency about how the loan’s terms were determined at any given point in time. By presenting these multiple dimensions—versions, balances, and rule sets—the logbook view gives users a full historical perspective of the instrument’s lifecycle. It offers an intuitive way to audit changes, ensure compliance with regulatory requirements, and analyze how various updates have impacted the financial status of the instrument. The logbook could also include links or drill-down options for users to explore more detailed reports or explanations of each version and its corresponding rules, further enhancing the user experience and data accessibility.

As shown in table 250, in a logbook view, different pieces of information, such as instrument characteristics, rule sets, time stamps, and other relevant data, can be hashed and included with the data values to ensure data integrity and traceability. Hashing is a cryptographic process that transforms this information into a unique, fixed-length string of characters (a hash), which can be used to verify the accuracy and authenticity of the data without revealing its underlying details. In the context of a logbook, each time a change occurs—whether it’s a modification to an instrument’s characteristics, an update to the rule sets, or the application of a specific time stamp—this information is hashed and stored alongside the data value displayed in the logbook.

For example, when a loan’s terms are updated with a new interest rate or repayment schedule, the updated instrument characteristics, along with relevant rule sets (such as the calculation methods or financial regulations applied), can be hashed and appended to the logbook entry. Similarly, the time stamps indicating when these changes were made, deployed, and became active would also be hashed to ensure that no alterations occur without detection. Each logbook entry would thus include not only the data value itself (e.g., the loan balance or version at a specific point in time) but also the corresponding hash that serves as a digital fingerprint for that entry.

This hashed data acts as an audit trail, allowing the system to verify that the information presented in the logbook has not been tampered with. If any changes to the data are made without authorization or proper processes, the hash will no longer match the original data, signaling potential discrepancies. Additionally, these hashes can be used to cross-reference different aspects of the data, such as ensuring that the rule sets applied to the instrument match the expected versions and that time stamps are consistent with the historical sequence of events. By incorporating hashed information into the logbook, the system ensures both transparency and security, allowing users to trust the accuracy of the data presented while maintaining a robust record for auditing and compliance purposes.

The system may also generate other information for display and provide partial replays by allowing specific historical transactions to be re-processed using updated instrument versions, while giving flexibility in deciding which portions of data to replay and over what timeframe. Each account in the system is assigned an Instrument Class when it is created, and this class typically remains constant unless a rare change is required. The system manages the versions of these instruments through an Instrument Version Control (IVC) Table, which specifies the appropriate instrument version (identified by an instrument hash) for each instrument class on any given day. The system relies on this table to determine which instrument version to use when processing both current and historical transactions.

When a new transaction (e.g., a processing request) is performed/received, the IVC Table is consulted to select the correct instrument version for the current effective date, and the transaction is processed accordingly. However, when a backdated command is received, which affects a prior effective date, the system rolls back to the final state of the instrument for that date. It processes the new backdated command using the appropriate instrument version from the IVC Table for that time and then reprocesses all subsequent transactions up to the current date, ensuring each is handled by the correct instrument version according to its effective date.

If the system determines to modify the behavior of an instrument class for future transactions, a new instrument version is released, and a corresponding entry is added to the IVC Table with an effective date in the future. This ensures that all future transactions will use the updated instrument version. Similarly, if a change needs to be backdated, the system adds a new instrument version to the IVC Table with an effective date in the past. This ensures that the new version will be used for any backdated transactions moving forward, but it does not automatically apply to transactions that were already processed. Thus, the historical transactions remain unchanged unless further steps are taken.

To manage these situations, the system provides an Account Replay tool, which allows for partial replays of historical transactions. Businesses can use this tool to reprocess individual accounts, batches of accounts, or all accounts associated with a particular instrument class, based on the changes made. This feature gives the flexibility to replay only the portions of a portfolio that require updates, without automatically affecting all past transactions. For example, if a bug fix or policy change needs to be applied retroactively, the system can release multiple instrument versions for different dates and offer the option to selectively reprocess accounts based on these changes.

The Account Replay tool also allows businesses to control the pace and scope of reprocessing. They can choose whether to re-run all past transactions immediately, or to gradually apply reprocessing over time, distributing the computational load or adjusting according to operational needs. This method ensures that the system maintains flexibility, offering precise control over which accounts and transactions are affected by backdated changes while providing the capability to replay historical data in a controlled and customizable manner.

In this updated system, each account is still assigned an Instrument Class when it is provisioned, but the process of managing instrument versions becomes more streamlined. Rather than storing a current instrument version (identified by an instrument hash) directly in the account and updating it during the end-of-day cycle, the system now relies entirely on the Instrument Version Control (IVC) Table to determine which instrument version to use for transaction processing. By eliminating the need to store and update the instrument version within each account, the system removes the overhead associated with maintaining and updating this information, simplifying the account management process. Instead, the necessary instrument version is dynamically pulled from the IVC Table when needed, and performance is not impacted because this data can be easily cached for efficiency.

This new approach also affects how the system handles backdated changes. Previously, the system had a capability under development to automatically replay transactions for all accounts of a given instrument class when a backdated change was made to the IVC Table. However, under this new model, automatic replays are no longer required, which is advantageous since reprocessing historical transactions for large numbers of accounts could be time-consuming. Instead, the focus shifts to developing an Account Replay Tool that can be used by lines of business (LOBs) to selectively replay transactions in a controlled manner. This tool will allow LOBs to determine when and how to apply replays based on backdated instrument changes, giving them more flexibility over how reprocessing is handled.

While the system no longer needs to store the current instrument version within each account, it will still maintain a record of which instrument version was used to process each individual transaction. This information will continue to be stored with the historical account state and evidence, ensuring that the system retains a verifiable audit trail. Maintaining this audit trail is essential for compliance and for reconstructing past transactions, allowing the system to provide transparency and traceability for all account activities. By shifting to this model, the system becomes more efficient, while still supporting the ability to track and audit historical transactions accurately.

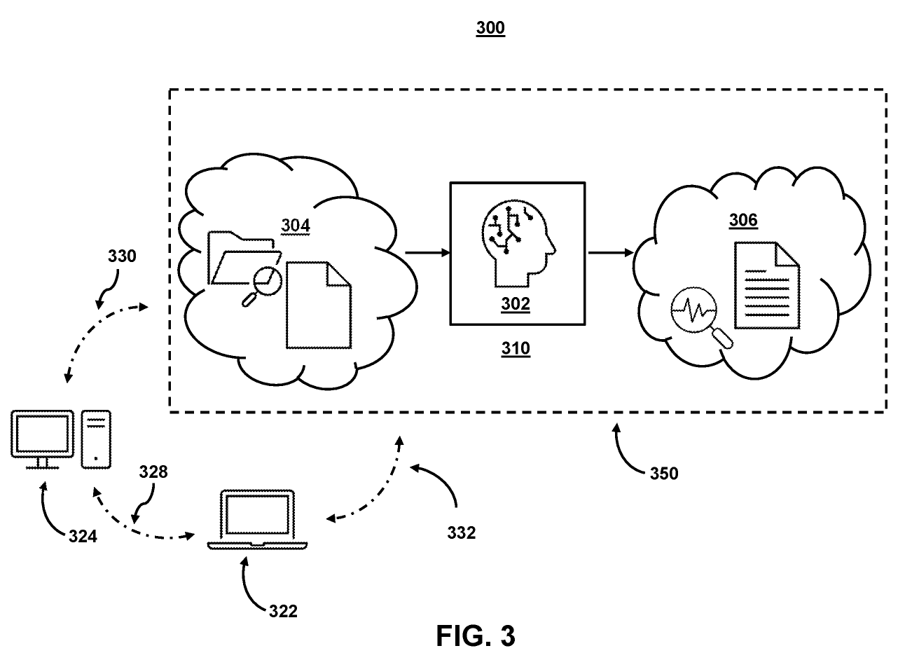

FIG. 3 shows illustrative components for a system for providing triangulating time stamps, in accordance with one or more embodiments. For example, FIG. 3 may show illustrative components for processing requests. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communication paths, such as a satellite path, a fiber-optic path, a cable path, a path that supports Internet communications (e.g., IPTV), free-space connections (e.g., for broadcast or other wireless signals), or any other suitable wired or wireless communication path or combination of such paths. The computing devices may include additional communication path linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results. These technical problems may present an inherent problem with attempting to use an artificial intelligence-based solution in processing sequential and potentially overlapping requests using triangulating time stamps.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., for processing sequential and potentially overlapping requests using triangulating time stamps).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network’s prediction and reference feedback. In a further use case, one or more neurons (or nodes) of the neural network may require that their respective errors are sent backward through the neural network to facilitate the update process (e.g., backpropagation of error). Updates to the connection weights, for example, may be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., for processing sequential and potentially overlapping requests using triangulating time stamps).

In some embodiments, the model (e.g., model 302) may automatically perform actions based on outputs 306. In some embodiments, the model (e.g., model 302) may not perform any actions. The output of the model (e.g., model 302) may be used for processing sequential and potentially overlapping requests using triangulating time stamps.

In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally, or alternatively, the system may adjust the inputs and/or outputs based on the determinations and/or predictions required. For example, for credit card eligibility, the model may evaluate the applicant’s likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively, or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

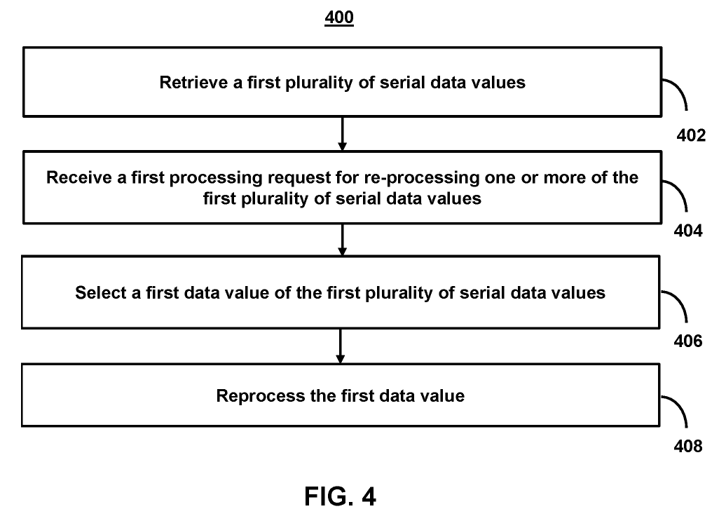

FIG. 4 shows a flowchart of the steps involved in processing sequential and potentially overlapping requests using triangulating time stamps, in accordance with one or more embodiments. For example, the system may use process 400 (e.g., as implemented on one or more system components described above) in order to process sequential and potentially overlapping requests using triangulating time stamps of encrypted data.

At step 402, process 400 (e.g., using one or more components described above) retrieves a first plurality of serial data values. For example, the system may retrieve a first plurality of serial data values in a first database, wherein each data value of the first plurality of serial data values corresponds to a respective result of a respective processing request performed at a respective time point.

For example, the system may retrieve a first plurality of serial data values from a first database, where each data value corresponds to the result of a specific processing request performed at a specific time point, the system typically follows a structured query process. First, the system identifies the relevant table or dataset within the database that stores the required information. A query is then constructed, often using a database management language such as SQL, to specify the conditions for selecting the serial data values. The query will likely include parameters that filter the results based on the time points associated with each processing request, ensuring that only the desired set of results is retrieved. These time points act as keys or identifiers that link each processing request to its respective result. Once the query is executed, the database engine processes it and retrieves the requested data values in sequence, ensuring that each result is associated with its corresponding request and time point. This retrieval process may also involve sorting the data chronologically or based on other criteria to maintain the serial nature of the data, ensuring the integrity of the information and its corresponding temporal sequence.

In some embodiments, the system may retrieve the first plurality of serial data values in the first database by receiving a user request comprising a first data characteristic and determining that the first plurality of serial data values has the first data characteristic. For example, to retrieve the first plurality of serial data values from the first database, the system begins by receiving a user request that includes a specific first data characteristic. This characteristic could represent a wide range of data attributes, such as a time period, a financial instrument, an account identifier, or any other defining feature that helps identify the relevant data. Upon receiving the request, the system analyzes the provided data characteristic to understand the scope of the data values the user is asking for. Next, the system queries the first database by filtering the stored data based on the first data characteristic. This involves scanning the database and identifying the subset of data values that match the specified characteristic. For example, if the first data characteristic relates to a specific date range, the system will identify and select all serial data values that were generated or modified within that time frame. If the characteristic pertains to an instrument type or version, the system will retrieve the serial data values associated with that instrument. Once the system determines that a first plurality of serial data values in the database shares the requested characteristic, it retrieves this data set. The retrieved data values are then organized according to the serial order in which they were originally stored or processed, ensuring that the sequence remains intact. The system can then present the retrieved data to the user, either in a report, as part of an analysis tool, or through the user interface, depending on the nature of the request. By using the first data characteristic to guide the retrieval, the system ensures that the user receives only the relevant serial data values, tailored to their specific query. This method provides an efficient and precise way of retrieving large sets of related data values from the database while preserving their original order and context.

In some embodiments, the system may retrieve the first plurality of serial data values in the first database by receiving, at a second time point, a second processing request for re-processing one or more of a second plurality of serial data values, wherein the second time point is prior to the first time point, determining a dependency between a second data value in the second plurality of serial data values in the first database, and determining to retrieve the first plurality of serial data values based on the dependency. For example, to retrieve the first plurality of serial data values from the first database, the system begins by receiving, at a second time point, a second processing request for re-processing one or more data values in a second plurality of serial data values. This second time point occurs prior to the first time point, meaning the request is for data that predates the original processing event or first request. Upon receiving the second processing request, the system starts by identifying the specific data values in the second plurality that need re-processing, using the time stamps or other identifiers provided in the request. During this re-processing, the system determines a dependency between one of the second data values in the second plurality and the data values in the first plurality of serial data values. This dependency indicates that the second data value is directly influenced by or related to the results or state of the first data value(s) from the first plurality. Such dependencies can arise when calculations, balances, or other transactions in the second plurality rely on prior data that was part of the first plurality. Recognizing this dependency, the system determines that it must retrieve the first plurality of serial data values in order to accurately process the second request. This ensures that any updates or reprocessing of the second data value are consistent with the previous data values it depends on. The system retrieves the relevant data from the first plurality, ensuring that it has the necessary context for processing the second request, particularly in cases where the second data value relies on historical transactions or states that are part of the first plurality. By identifying and acting on this dependency, the system ensures that the reprocessing of the second data value is both accurate and complete, taking into account the relevant historical data from the first plurality. This approach allows the system to maintain the integrity of the data across multiple time points, ensuring that dependencies are properly managed and reflected in any reprocessed results.

At step 404, process 400 (e.g., using one or more components described above) receives a first processing request for re-processing one or more of the first plurality of serial data values. For example, the system may receive, at a first time point, a first processing request for re-processing one or more of the first plurality of serial data values, wherein the first processing request comprises an effective date time stamp indicating when the first processing request is effective to generate a result, an active date time stamp indicating when the first processing request is active, and a deployment date time stamp indicating when the first processing request is deployed.

When a system receives a first processing request at a first time point for re-processing one or more of a first plurality of serial data values, it utilizes a combination of time stamps to manage the timing and execution of the request. The first processing request includes three critical time stamps: an effective date time stamp, an active date time stamp, and a deployment date time stamp. Upon receiving the request, the system first notes the deployment date time stamp, which indicates when the request was initially received and deployed by the system. This time stamp is essential for logging the request and maintaining an audit trail, ensuring that the system can track when the request was introduced, even if it will affect past or future processing. Next, the system evaluates the effective date time stamp, which indicates when the processing request is effective for generating a result. This time stamp ensures that the system understands which specific date or period the re-processing should affect. If the request involves recalculating data for a past period, the effective date directs the system to apply the requested changes as if they were in place on that earlier date, ensuring that any historical re-processing aligns with the correct version of the data or instruments for that time. Finally, the system checks the active date time stamp, which signals when the processing request should be actively used. This time stamp allows the system to schedule or delay the actual re-processing, ensuring that the new request is only applied when appropriate. For example, the request may be deployed at one point in time but may not take effect until a later, specified active date. This allows flexibility in when the processing request is executed without immediately impacting current data. By using these three time stamps—effective, active, and deployment—the system can accurately manage when and how re-processing requests are applied, ensuring both historical accuracy and future readiness. This structure also allows for a clear separation between when a request is received, when it takes effect, and when it actively modifies the data, providing control and flexibility in handling complex re-processing scenarios.

At step 406, process 400 (e.g., using one or more components described above) selects a first data value of the first plurality of serial data values. For example, the system may select, based on the active date time stamp, a first data value of the first plurality of serial data values for reprocessing. For example, the system may select the first data value for reprocessing by leveraging the active date time stamp provided in the processing request. The active date time stamp indicates when the request should take effect and be applied to the relevant data. When the system receives this request, it first identifies the range of serial data values that correspond to the timeframe in question. Using the active date time stamp, the system filters through the first plurality of serial data values to find the specific data points that fall within the active date’s window. Once the system has located the time range defined by the active date, it then identifies the first data value within the serial data that aligns with that point in time. This data value is selected for reprocessing because it is the earliest instance affected by the new active request. The system may also verify that the instrument version or rule set applicable at that time is correctly aligned with the specified active date to ensure that the reprocessing occurs with the appropriate logic and rules in place. By using the active date time stamp in this way, the system ensures that the reprocessing starts with the correct data point, reflecting the requested changes exactly from the intended moment in time. This process allows for precise and accurate reprocessing, ensuring that subsequent data values are reprocessed sequentially based on the same set of criteria.

In some embodiments, the system may select the first data value of the first plurality of serial data values for reprocessing by determining a first rule set for the first data value, determining an initial result for the first data value, and replacing the first rule set based on the first processing request. For example, to select the first data value of the first plurality of serial data values for reprocessing, the system begins by determining the first rule set that was originally applied to the first data value. This rule set includes the specific logic, formulas, or conditions that governed the initial processing of the data, such as financial calculations, account state updates, or other transaction-specific rules. By identifying this rule set, the system gains a clear understanding of how the initial result for the first data value was derived. Next, the system retrieves the initial result for the first data value, which represents the outcome of the original processing. This result may include metrics such as balances, transaction states, or other key outputs that were produced based on the first rule set. The initial result provides a baseline for comparing how the data will change during the reprocessing. Upon receiving the first processing request, the system then determines whether the first rule set needs to be replaced or modified. This typically happens when the processing request specifies a new rule set or updated logic that must be applied to the first data value. The system replaces the original rule set with the new one, ensuring that the updated rules are now used to reprocess the first data value. Once the new rule set is in place, the system applies it to the first data value, recalculating or updating the initial result to reflect the new logic. This reprocessing ensures that the data is consistent with the latest rules or regulations specified in the first processing request. By systematically replacing the rule set and reprocessing the first data value, the system ensures that all relevant changes are accurately reflected in the final result, maintaining data integrity and consistency across the reprocessed dataset.

In some embodiments, the system may select the first data value of the first plurality of serial data values for reprocessing by determining a first instrument corresponding to the first data value and reprocessing the first instrument based on a rule set in the first processing request. For example, the system may select the first data value of the first plurality of serial data values for reprocessing by first determining the first instrument that corresponds to the data value. An instrument in this context could represent a financial instrument, such as a loan, account balance, or any other entity that the data value is tied to. The system identifies this specific instrument, which is linked to the first data value, ensuring that it understands the context and the scope of the data involved. Once the system has identified the first instrument, it refers to the rule set provided in the first processing request. This rule set outlines the updated logic, conditions, or calculations that need to be applied to the instrument. The system replaces or modifies any previous rules that were initially applied to the instrument during its original processing and prepares to reprocess the instrument using the new rules specified in the request. With the updated rule set in place, the system reprocesses the first instrument by applying the new logic or calculations. This could involve recalculating financial metrics, adjusting balances, updating state transitions, or modifying other attributes related to the instrument, depending on the nature of the rule set. The result of this reprocessing reflects the changes dictated by the new rules, ensuring that the data value associated with the first instrument is now aligned with the latest instructions from the first processing request. By reprocessing the instrument based on the updated rule set, the system ensures that all relevant data values tied to the instrument are correctly updated, maintaining consistency and accuracy in the overall dataset. This method allows the system to efficiently handle complex reprocessing tasks by targeting specific instruments and applying rule changes in a structured and precise manner.

In some embodiments, the system may select the first data value of the first plurality of serial data values for reprocessing by comparing the active date time stamp and the effective date time stamp to the respective time point of each data value of the first plurality of serial data values and determining the respective time point for the first data value corresponds to the active date time stamp and the effective date time stamp. For example, the system may select the first data value from the first plurality of serial data values for reprocessing by comparing the active date time stamp and the effective date time stamp from the first processing request with the respective time points of each data value in the first plurality. Each data value in the series has a corresponding time point that reflects when it was initially processed or recorded. The system begins by evaluating each data value’s time point and comparing it to the time stamps provided in the processing request. The active date time stamp indicates when the request becomes active, determining the moment from which the system should apply the updated rules or logic. The effective date time stamp reflects the point in time when the changes dictated by the request are meant to be applied retroactively or prospectively to the data values. The system compares both these time stamps to the time points of the data values to identify which specific data values fall within the scope of the request. When the system finds a data value whose respective time point matches or corresponds to both the active and effective date time stamps, it identifies this as the first data value for reprocessing. This ensures that the system selects the correct data value based on the temporal context provided in the processing request. The selected data value is then reprocessed according to the new rules or logic specified in the request, ensuring that any historical or future data values falling within the time frame of the active and effective dates are correctly updated. By using this method, the system ensures that reprocessing occurs in the correct time sequence and applies the rule changes only to the data values that are relevant to the time stamps provided in the request. This maintains accuracy and consistency in how the system handles data across different time periods.

At step 408, process 400 (e.g., using one or more components described above) reprocesses the first data value. For example, the system may execute the first processing request on the first data value. To execute a first processing request on the first data value, the system follows a structured process that ensures accuracy and consistency. Once the first data value is selected based on the active date time stamp, the system retrieves the relevant information needed for reprocessing, such as the instrument version, rule sets, and any other applicable parameters. These components are critical because they define how the data value should be processed in accordance with the request. The system then applies the rules and calculations specified by the request to the first data value. This may involve recalculating financial figures, adjusting balances, updating states, or applying new logic, depending on the nature of the processing request. The effective date time stamp in the request guides the system to ensure that any changes are applied retroactively or in real time as necessary. Additionally, if the request involves historical adjustments, the system makes sure that the appropriate instrument version or configuration, valid at the time specified by the effective date, is used during the recalculation. Once the calculations or updates are performed, the system generates the result and stores it, updating the record associated with the first data value. The result might include new values, such as updated balances, or reflect a new state for the instrument or transaction in question. During this process, the system also maintains an audit trail by recording the instrument hash or version used, ensuring that the reprocessing is verifiable and transparent for future audits. Finally, the system checks if any additional reprocessing is needed for subsequent data values and continues reprocessing them in sequence if required. By executing the request on the first data value in this precise and controlled manner, the system ensures that the results are consistent with both the historical context and the rules defined by the new request.

In some embodiments, the system may execute the first processing request on the first data value by selecting, based on the active date time stamp, a second data value of the first plurality of serial data values for reprocessing and executing the first processing request on the second data value. For example, after executing the first processing request on the first data value, the system proceeds to handle subsequent data values in the series by continuing to reference the active date time stamp. Based on the sequence of serial data values and their associated time stamps, the system identifies the second data value that falls within the scope of the processing request. This second data value is selected for reprocessing because it follows the first data value in the temporal sequence and is subject to the same or related processing rules as dictated by the active date time stamp. Once the second data value is selected, the system retrieves the relevant instrument version, rule sets, and any other necessary context for that specific time period. These components are critical to ensure that the system applies the correct logic and calculations for reprocessing. Just like with the first data value, the system applies the new rules or modifications specified by the first processing request to the second data value. This could involve recalculating figures, adjusting states, or updating balances, all while ensuring that the correct version of the instrument or logic is applied based on the effective date and active date of the request. After executing the request on the second data value and updating the result, the system continues to maintain an audit trail, ensuring that the process is fully traceable. It logs the instrument hash or version used during the reprocessing of the second data value, along with any changes made. The system then checks if there are further data values in the sequence that need reprocessing under the same request. If so, it repeats the process, selecting the next data value and applying the necessary rules. This approach allows the system to efficiently, and systematically, reprocess a series of data values, ensuring that the changes dictated by the first processing request are applied consistently across all relevant data points. By using the active date time stamp to guide the selection and reprocessing of each data value, the system maintains temporal accuracy and ensures that the reprocessing is completed in the correct sequence.

In some embodiments, the system may execute the first processing request on the first data value by determining a second data value is dependent of the first data value and executing the first processing request on the second data value based on determining the second data value is dependent of the first data value. When executing the first processing request on the first data value, the system may determine that a second data value is dependent on the first data value, meaning that the second value is directly influenced by or derived from the result of the first. To handle this, the system first processes the first data value according to the rules and instructions specified in the request. After updating the first data value, the system then assesses whether other data values in the sequence are linked to or depend on this initial value. Dependencies between data values may exist in cases where financial calculations, state transitions, or other logical relationships rely on a preceding value's outcome. For example, in a financial transaction series, the balance of an account at one point in time (second data value) may depend on the balance after processing a prior transaction (first data value). Once the system identifies that the second data value is dependent on the result of the first, it ensures that the reprocessing of the second value is based on the updated result of the first. The system proceeds by applying the same processing request to the second data value, but with the awareness that this value is influenced by the now-updated first data value. It recalculates or updates the second data value, accordingly, ensuring that all dependencies are correctly managed. By following this approach, the system ensures that the changes made to the first data value propagate correctly to the second value, maintaining consistency across the series of dependent data values. After reprocessing the second data value, the system continues to check for further dependencies in the data sequence. If additional data values are dependent on either the first or second values, the system reprocesses them in the correct order, ensuring that all changes are logically consistent and accurate. This method ensures that the system properly handles interdependencies between data values, maintaining the integrity of the entire dataset while processing the request.

In some embodiments, the system may execute the first processing request on the first data value by generating a first result based on the first processing request and replacing an initial result for the first data value with the first result. For example, to execute the first processing request on the first data value, the system begins by generating a first result based on the instructions and logic defined in the request. This involves retrieving the necessary parameters—such as rule sets, instrument versions, or other contextual data—required to process the first data value. The system then applies the specific calculations, transformations, or updates dictated by the processing request to the first data value, generating the new result. This first result reflects the changes or updates that the request is intended to achieve, whether it is recalculating a financial balance, updating a state, or adjusting a condition based on new rules. Once the first result is generated, the system compares it to the initial result—the existing value or outcome that was originally associated with the first data value. If the new result differs from the initial result, the system proceeds to replace the initial result with the newly generated first result. This update ensures that the first data value now reflects the changes specified by the first processing request. In the process of replacing the initial result, the system may also update associated metadata or logs. For example, it will record the instrument version or rule set used in generating the new result and update any relevant audit trails to document the reprocessing action. This ensures that the reprocessing of the first data value is fully traceable, and the system can always verify how and when the first result was produced. By replacing the initial result with the first result, the system ensures that the data value reflects the latest processing logic and remains consistent with the requested changes. This method ensures that any outdated or inaccurate results are corrected, and the system maintains an accurate, up-to-date record of the first data value as part of the overall reprocessing operation.

In some embodiments, the system may execute the first processing request on the first data value by generating a first result based on the first processing request and storing the first result in a blockchain for the first plurality of serial data values. For example, to execute the first processing request on the first data value and store the result in a blockchain, the system begins by generating a first result based on the instructions defined in the request. This process involves retrieving all necessary contextual data—such as rule sets, instrument versions, or any other relevant information—and applying the appropriate logic or calculations to the first data value. The system computes the new result based on the first processing request, which could include recalculating financial metrics, updating account states, or adjusting other parameters tied to the data value. Once the first result is generated, the system prepares it for storage in the blockchain that is a distributed and immutable ledger. The blockchain is ideal for this purpose because it provides transparency, security, and a verifiable record of changes, which is particularly useful for tracking a series of data values over time. To store the first result, the system packages the result along with any relevant metadata, such as the time stamps (effective date, active date, and deployment date) and the instrument version used in generating the result. Next, the system creates a block for this specific data value, which includes the first result and its associated metadata, such as the instrument hash and a cryptographic signature to ensure data integrity. This block is then appended to the blockchain, becoming part of the permanent, sequential record of the first plurality of serial data values. Each block is cryptographically linked to the previous one, ensuring that the entire chain of data values is secure and tamper-proof. This way, any changes made to the first data value, as well as subsequent data values, are permanently recorded and can be audited or verified at any point in the future. By storing the first result in the blockchain, the system ensures that the updated data value is immutable, transparent, and traceable. This not only guarantees the integrity of the result but also allows any authorized parties to access the history of changes for the entire dataset, including the specific logic and instrument versions applied during each reprocessing event. Storing the first result in a blockchain adds a robust layer of security and trust to the overall system, ensuring that all future references to the first data value are based on an immutable record.

In some embodiments, the system executes the first processing request on the first data value by generating a first result based on the first processing request and generating a first hash based on the first result and the first processing request. In some cases, the system may generate the first hash based on the first result and the first processing request by determining the effective date time stamp for the first processing request and hashing the effective data time stamp, deployment data time stamp, and/or other information to generate the first hash. For example, to execute the first processing request on the first data value and generate a first hash based on the result and the request, the system follows a structured process. Initially, the system retrieves all relevant information for processing, such as the instrument version, rule sets, and time stamps. It then applies the logic specified by the first processing request to the first data value, generating a first result. This result could represent recalculated financial values, updated states, or other changes to the data based on the new instructions. After generating the first result, the system proceeds to create a first hash that uniquely identifies and secures the combination of the result and the processing request. In this step, the system collects critical elements of the processing request—such as the effective date time stamp, active date, and instrument version—along with the first result itself. By combining these key pieces of information, the system ensures that the hash will uniquely represent both the outcome of the request and the underlying conditions under which it was processed. In some cases, the system specifically uses the effective date time stamp as a primary input for generating the first hash. The effective date, which indicates when the request is valid for applying changes, is crucial because it ensures that the hash reflects the temporal context of the reprocessing. The system hashes this time stamp along with the first result, creating a cryptographic signature that ties the result to the exact time and logic of the processing request. This hash serves as a fingerprint for the transaction, ensuring that any future reference to this data value can be traced back to the specific conditions and rules applied during its reprocessing. Once the first hash is generated, it is stored along with the first result, providing a secure and verifiable record of the reprocessing. The hash guarantees that neither the result nor the request can be altered without detection; any changes to the first result or the conditions under which it was processed would generate a different hash, ensuring the integrity of the data. This process adds a layer of security and traceability, allowing the system to reference and validate the reprocessed data value and its corresponding request in the future, while also ensuring that the effective date, processing logic, and outcome are all immutably linked through the hash.

In some embodiments, the system may generate the first hash based on the first result and the first processing request by appending the first data value with the first hash to generate an appended first data value and storing the appended first data value in the first database. For example, to generate the first hash based on the first result and the first processing request, the system begins by processing the first data value according to the request. This involves applying the relevant rule sets, instrument versions, and time stamps (such as the effective date) to generate the updated first result. Once the system has the first result, it proceeds to generate a cryptographic first hash, which serves as a unique identifier for the result and the processing request. The system generates the first hash by combining the key elements of the processing request—such as the first result, the effective date time stamp, and other relevant metadata like the instrument version. This cryptographic process produces a hash that uniquely represents the relationship between the result and the specific conditions under which it was processed, ensuring that any modification to the data or request will be immediately detectable. Next, the system appends the first data value with the generated hash. The appended first data value now contains not only the original data or updated result but also the first hash, which securely ties the result to the specific processing request. This appended structure ensures that the first data value is tamper-proof, as any attempt to alter the result or the associated metadata would result in a mismatch with the stored hash. Once the first data value is appended with the hash, the system stores the appended data value in the first database. By doing so, the system preserves both the updated result and its verifiable link to the processing request, creating a reliable and secure record. The appended first data value, now stored in the database, can be accessed and referenced in the future, ensuring that the system can always verify the integrity of the data and trace it back to the exact processing logic and time it was applied. This process enhances the reliability and security of the system, as the appended first data value—with its embedded hash—ensures that all processing steps and results are fully traceable and protected against unauthorized changes.

In some embodiments, the system may execute the first processing request on the first data value by generating a first result based on the first processing request and populating the first data value with the first result. For example, to execute the first processing request on the first data value, the system begins by applying the logic and rules specified in the request. This involves retrieving necessary contextual information, such as the instrument version, rule sets, and relevant time stamps (e.g., effective date), which govern how the first data value should be processed. The system then processes the first data value according to these instructions, calculating or updating the data to generate a first result. Once the first result is generated, it represents the updated state of the data value, whether that involves recalculating a financial figure, updating a balance, modifying a state, or applying other changes specified by the processing request. The system then populates the original first data value with this new result, effectively replacing the old data or adding the new information to reflect the latest update. By populating the first data value with the first result, the system ensures that the data value now accurately reflects the changes dictated by the first processing request. The system may also update associated metadata, such as time stamps or audit logs, to record that the first data value has been modified based on the latest request. This ensures traceability and provides an audit trail that links the processing request to the updated data value. After populating the first data value with the first result, the system stores or updates this data value in the database, ensuring that it is now part of the current dataset. This process ensures that the result of the processing request is applied consistently and is immediately available for any future queries, reports, or further processing tasks. By populating the first data value in this way, the system maintains data integrity and ensures that the updated information is seamlessly integrated into the existing dataset.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method, the method for processing sequential and potentially overlapping requests using triangulating time stamps.
2. The method of the preceding embodiment, further comprising: retrieving a first plurality of serial data values in a first database, wherein each data value of the first plurality of serial data values corresponds to a respective result of a respective processing request performed at a respective time point; receiving, at a first time point, a first processing request for re-processing one or more of the first plurality of serial data values, wherein the first processing request comprises an effective date time stamp indicating when the first processing request is effective to generate a result, an active date time stamp indicating when the first processing request is active, and a deployment date time stamp indicating when the first processing request is deployed; selecting, based on the active date time stamp, a first data value of the first plurality of serial data values for reprocessing; and executing the first processing request on the first data value.
3. The method of any one of the preceding embodiments, wherein executing the first processing request on the first data value further comprises: selecting, based on the active date time stamp, a second data value of the first plurality of serial data values for reprocessing; and executing the first processing request on the second data value.
4. The method of any one of the preceding embodiments, wherein executing the first processing request on the first data value further comprises: determining a second data value is dependent of the first data value; and executing the first processing request on the second data value based on determining the second data value is dependent of the first data value.
5. The method of any one of the preceding embodiments, wherein executing the first processing request on the first data value further comprises: generating a first result based on the first processing request; and replacing an initial result for the first data value with the first result.
6. The method of any one of the preceding embodiments, wherein executing the first processing request on the first data value further comprises: generating a first result based on the first processing request; and storing the first result in a blockchain for the first plurality of serial data values.
7. The method of any one of the preceding embodiments, wherein executing the first processing request on the first data value further comprises: generating a first result based on the first processing request; and generating a first hash based on the first result and the first processing request.
8. The method of any one of the preceding embodiments, wherein generating the first hash based on the first result and the first processing request further comprises: determining the effective date time stamp for the first processing request; and hashing the effective data time stamp to generating the first hash.
9. The method of any one of the preceding embodiments, wherein generating the first hash based on the first result and the first processing request further comprises: determining the deployment date time stamp for the first processing request; and hashing the deployment date time stamp to generating the first hash.
10. The method of any one of the preceding embodiments, wherein generating the first hash based on the first result and the first processing request further comprises: appending the first data value with the first hash to generate an appended first data value; and storing the appended first data value in the first database.
11. The method of any one of the preceding embodiments, wherein executing the first processing request on the first data value further comprises: generating a first result based on the first processing request; and populating the first data value with the first result.
12. The method of any one of the preceding embodiments, wherein retrieving the first plurality of serial data values in the first database further comprises: receiving a user request comprising a first data characteristic; and determining that the first plurality of serial data values has the first data characteristic.
13. The method of any one of the preceding embodiments, wherein retrieving the first plurality of serial data values in the first database further comprises: receiving, at a second time point, a second processing request for re-processing one or more of a second plurality of serial data values, wherein the second time point is prior to the first time point; determining a dependency between a second data value in the second plurality of serial data values in the first database; and determining to retrieve the first plurality of serial data values based on the dependency.
14. The method of any one of the preceding embodiments, wherein selecting the first data value of the first plurality of serial data values for reprocessing further comprises: determining a first rule set for the first data value; determining an initial result for the first data value; and replacing the first rule set based on the first processing request.
15. The method of any one of the preceding embodiments, wherein selecting the first data value of the first plurality of serial data values for reprocessing further comprises: determining a first instrument corresponding to the first data value; and reprocessing the first instrument based on a rule set in the first processing request.
16. The method of any one of the preceding embodiments, wherein selecting the first data value of the first plurality of serial data values for reprocessing further comprises: comparing the active date time stamp and the effective date time stamp to the respective time point of each data value of the first plurality of serial data values; and determining the respective time point for the first data value corresponds to the active date time stamp and the effective date time stamp.
17. One or more non-transitory, computer-readable mediums storing instructions that, when executed by a data processing apparatus, cause the data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

What is claimed is:

1. A system for processing sequential and potentially overlapping requests using triangulating time stamps of encrypted data, the system comprising:
one or more processors; and
one or more non-transitory, computer-readable media, comprising instructions that, when executed by one or more processors, cause operations comprising:
retrieving a first plurality of serial data values in a first encrypted database, wherein each data value of the first plurality of serial data values corresponds to a respective secured result of a respective secured processing request performed at a respective time point;
receiving, at a first time point, a first processing request for re-processing one or more of the first plurality of serial data values, wherein the first processing request comprises an effective date time stamp indicating when the first processing request is effective to generate a secured result, an active date time stamp indicating when the first processing request is active to process data in the first encrypted database, and a deployment date time stamp indicating when the first processing request is deployed on the first encrypted database;
selecting, based on comparing the active date time stamp and the effective date time stamp to the respective time point of each data value of the first plurality of serial data values, a first data value of the first plurality of serial data values for reprocessing; and
executing the first processing request on the first data value.

2. A method for processing sequential and potentially overlapping requests using triangulating time stamps, the method comprising:
retrieving a first plurality of serial data values in a first database, wherein each data value of the first plurality of serial data values corresponds to a respective result of a respective processing request performed at a respective time point;
receiving, at a first time point, a first processing request for re-processing one or more of the first plurality of serial data values, wherein the first processing request comprises an effective date time stamp indicating when the first processing request is effective to generate a result, an active date time stamp indicating when the first processing request is active, and a deployment date time stamp indicating when the first processing request is deployed;
selecting, based on the active date time stamp, a first data value of the first plurality of serial data values for reprocessing; and
executing the first processing request on the first data value.

3. The method of claim 2, wherein executing the first processing request on the first data value further comprises:
selecting, based on the active date time stamp, a second data value of the first plurality of serial data values for reprocessing; and
executing the first processing request on the second data value.

4. The method of claim 2, wherein executing the first processing request on the first data value further comprises:
determining a second data value is dependent of the first data value; and
executing the first processing request on the second data value based on determining the second data value is dependent of the first data value.

5. The method of claim 2, wherein executing the first processing request on the first data value further comprises:
generating a first result based on the first processing request; and
replacing an initial result for the first data value with the first result.

6. The method of claim 2, wherein executing the first processing request on the first data value further comprises:
generating a first result based on the first processing request; and
storing the first result in a blockchain for the first plurality of serial data values.

7. The method of claim 2, wherein executing the first processing request on the first data value further comprises:
generating a first result based on the first processing request; and
generating a first hash based on the first result and the first processing request.

8. The method of claim 7, wherein generating the first hash based on the first result and the first processing request further comprises:
determining the effective date time stamp for the first processing request; and
hashing the effective data time stamp to generate the first hash.

9. The method of claim 7, wherein generating the first hash based on the first result and the first processing request further comprises:
determining the deployment date time stamp for the first processing request; and
hashing the deployment date time stamp to generate the first hash.

10. The method of claim 7, wherein generating the first hash based on the first result and the first processing request further comprises:
appending the first data value with the first hash to generate an appended first data value; and
storing the appended first data value in the first database.

11. The method of claim 2, wherein executing the first processing request on the first data value further comprises:
generating a first result based on the first processing request; and
populating the first data value with the first result.

12. The method of claim 2, wherein retrieving the first plurality of serial data values in the first database further comprises:
receiving a user request comprising a first data characteristic; and
determining that the first plurality of serial data values has the first data characteristic.

13. The method of claim 2, wherein retrieving the first plurality of serial data values in the first database further comprises:
receiving, at a second time point, a second processing request for re-processing one or more of a second plurality of serial data values, wherein the second time point is prior to the first time point;
determining a dependency between a second data value in the second plurality of serial data values in the first database; and
determining to retrieve the first plurality of serial data values based on the dependency.

14. The method of claim 2, wherein selecting the first data value of the first plurality of serial data values for reprocessing further comprises:
determining a first rule set for the first data value;
determining an initial result for the first data value; and
replacing the first rule set based on the first processing request.

15. The method of claim 2, wherein selecting the first data value of the first plurality of serial data values for reprocessing further comprises:
determining a first instrument corresponding to the first data value; and
reprocessing the first instrument based on a rule set in the first processing request.

16. The method of claim 2, wherein selecting the first data value of the first plurality of serial data values for reprocessing further comprises:
comparing the active date time stamp and the effective date time stamp to the respective time point of each data value of the first plurality of serial data values; and
determining the respective time point for the first data value corresponds to the active date time stamp and the effective date time stamp.

17. One or more non-transitory, computer-readable media, comprising instructions that, when executed by one or more processors, cause operations comprising:
retrieving a first plurality of serial data values in a first database, wherein each data value of the first plurality of serial data values corresponds to a respective result of a respective processing request performed at a respective time point;
receiving, at a first time point, a first processing request for re-processing one or more of the first plurality of serial data values, wherein the first processing request comprises an effective date time stamp indicating when the first processing request is effective to generate a result;
selecting, based on the active date time stamp, a first data value of the first plurality of serial data values for reprocessing; and
executing the first processing request on the first data value.

18. The one or more non-transitory, computer-readable media of claim 17, wherein executing the first processing request on the first data value further comprises:
selecting, based on the active date time stamp, a second data value of the first plurality of serial data values for reprocessing; and
executing the first processing request on the second data value.

19. The one or more non-transitory, computer-readable media of claim 17, wherein executing the first processing request on the first data value further comprises:
determining a second data value is dependent of the first data value; and
executing the first processing request on the second data value based on determining the second data value is dependent of the first data value.

20. The one or more non-transitory, computer-readable media of claim 17, wherein executing the first processing request on the first data value further comprises:
generating a first result based on the first processing request; and
replacing an initial result for the first data value with the first result.
